(19) United States
(12) Patent Application Publication
(10) Pub. No.: US 2008/0112383 A1
(43) Pub. Date: May 15, 2008

(54) METHOD FOR ESTABLISHING REVERSE TRAFFIC CHANNELS AND AN ACCESS TERMINAL

(75) Inventor: Peng LI, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 12/016,068

(22) Filed: Jan. 17, 2008

Related U.S. Application Data
(63) Continuation of application No. PCT/CN2006/001730, filed on Jul. 18, 2006.

(30) Foreign Application Priority Data
Jul. 18, 2005 (CN) 200510084245.8

(51) Int. Cl. H04B 7/216

(52) U.S. Cl. 370/342

(57) ABSTRACT

A method for establishing reverse traffic channels in a multi-carrier wireless communication system includes: an access terminal (AT) sending a carrier request message to an access network (AN), said carrier request message carrying a reverse carrier request indicator indicating the number of reverse carrier links required by AT (S1); AN sending a traffic channel assignment message carried with a reverse traffic channel information to AT (S12); AT establishing reverse traffic channels according to the traffic channel assignment message, and sending a pilot and data rate control signal (S13); AT sending a channel establishment complete information over the reverse traffic channel (S15); and transferring data by using said channel (S16). AT requests the number of reverse carriers from AN on its own initiative without any modification to the previous messages, thus backward compatibility is maintained. AT can dynamically and flexibly request reverse carriers according to its own demand.

This application is a continuation application of international patent application No. PCT/CN2006/001730 filed on Jul. 18, 2006 and titled with “A method for establishing reverse traffic channel and an access terminal”, which claims priority from the Chinese patent application No. 200510084245 filed on Jul. 18, 2005, the contents of which are incorporated in its entirety by reference.

### FIELD OF THE PRESENT INVENTION

The present invention relates to the field of communications, and in particular to a method for establishing reverse traffic channels in a multi-carrier wireless communication system and an access terminal.

### BACKGROUND OF THE PRESENT INVENTION

Single-carrier transmission is employed in the existing CDMA2000 1xEV-DO (Evolution-Data Optimization) systems. With the development of data traffic, higher data transmission rate is required. 3GPP2 proposes a new air interface evolution scheme. In the first stage of this scheme, multi-carrier EV-DO (NxEV-DO) is employed to increase data rate of the air interface greatly, the forward rate is required to be not less than N times of 3.1 Mbps and the reverse rate not less than N times of 1.8 Mbps, where N is the number of carriers employed in an access network (AN) or an access terminal (AT). Moreover, it is required that forward carriers and reverse carriers be allocated dynamically and independently by cooperation between the AN and the AT, the number of forward carriers is not necessarily symmetrical to that of the reverse carriers.

However, in the existing 1xEV-DO systems, an AT only uses a reverse carrier link to transmit information, and does not have the function of requesting a reverse traffic channel.

FIG. 1 shows a structural diagram of a 1xEV-DO system. In the system, a carrier from a transmitting tower to an AT is a forward carrier, and a carrier from an AT to a transmitting tower is a reverse carrier. Each part of the system is as follows.

Access Network (AN): an AN is a network device providing data connection between a Packet Data Network (such as Internet) and an AT.

Packet Control Function unit (PCF): a PCF mainly provides functions of mapping between a wireless link and a wired link, call control, mobility management, session management, data buffering and forwarding, charging information collection, etc.

Packet Data Service Node (PDSN): a PDSN mainly provides functions of link management, mobility management, address allocation, charging information collection, data routing, tunnel packaging, etc., and supports foreign proxy of Mobile IP.

Authentication, Authorization and Accounting Server (AAA server): an AAA server mainly provides functions of identity authentication and address allocation.

Mobile Switching Center (MSC): an MSC is a circuit-domain voice switching center. Circuit-domain voice traffics are connected through the MSC.

In the existing 1xEV-DO systems, an AT needs to establish a connection when performing configuration negotiation and establishing a traffic channel. There may be the following cases:

1. An AT initiates a connection request on its own initiative.

2. An AN sends a paging message, and an AT initiates a connection request upon receiving the message.

3. A session is initially established and configuration negotiation is needed.

FIG. 2 shows a flow chart of a process in which an AT initiates a Connection Request on its own initiative, which mainly includes the following steps:

S01: An AT sends a connection request and starts a timer;

S02: The AT sends a Route Update message indicating the wireless environment;

S03: An AN sends an MAC Layer ACK message acknowledging receipt of the message;

S04: The AN sends a Channel Assignment message;

S05: The AT establishes a reverse traffic channel (RTC) and sends a pilot and a DRC signal;

S06: The AN sends an RTC ACK message acknowledging receipt of the reverse traffic channel;

S07: The AT sends a Traffic Channel Establishment Complete message on the traffic channel and stops the timer; and

S08: The AT and the AN start data exchange.

The inventor found that the prior art has the following drawbacks:

1. The AT does not have the capability of initiatively requesting a reverse carrier from the AN;

2. The AN does not know the number of reverse carrier links the AT needs;

3. Only one reverse carrier link can be allocated to the AT, and the peak rate is only 1.8 Mbps; and

4. The forward and reverse data rates cannot meet the future traffic requirements.

### SUMMARY OF THE PRESENT INVENTION

The present invention provides a method for requesting a multi-carrier EV-DO reverse carrier and an access terminal (AT) to solve the problems of the prior art that an AT does not have the capability of initiatively requesting a reverse carrier from an access network (AN) and the AN does not know the reverse carriers the AT needs.

A method for establishing a reverse channel including:

an AT sends a Carrier Request message to an AN. The Carrier Request message carries a reverse carrier request ID identifying the number of reverse carrier links that the AT needs;

the AN sends a Traffic Channel Assignment message to the AT. The Traffic Channel Assignment message carries reverse traffic channel information;

the AT establishes a reverse traffic channel according to the Traffic Channel Assignment message, and sends a Pilot and a DRC signal; and

the AT sends a Traffic Channel Establishment Complete message on the reverse traffic channel, and transmits data through the channel.

In the step that the AT sends a Carrier Request message to the AN, the reverse channel request message is sent on an access channel of the AT.

In the step that the AT sends a Carrier Request message to the AN, the Carrier Request message is sent on a reverse traffic channel that has been established between the AT and the AN.

In the step that the AT sends a Carrier Request message to the AN, the Carrier Request message is obtained by extending a Route Update message.

In the step that the AT sends a Carrier Request message to the AN, a reverse carrier request field is added to the Route Update message.

In the step that the AT sends a Carrier Request message to the AN, the reverse carrier request ID includes a message ID, a transaction ID and a reverse link carrier number ID.

The step that the AT sends a Traffic Channel Establishment Complete message on the reverse traffic channel further includes:

The AN sends an RTC ACK message acknowledging receipt of the reverse traffic channel.

The step that the AT sends a Traffic Channel Establishment Complete message on the reverse traffic channel further includes:

The AT sends a Reverse Traffic Channel Establishment Complete message on the newly established reverse traffic channel.

The step that the AT sends a Carrier Request message to the AN further includes starting a timer. In the step that the AT sends a Traffic Channel Establishment Complete message on the reverse traffic channel, the timer is stopped after the Reverse Traffic Channel Establishment Complete message is sent.

In the step that the AT sends a Traffic Channel Establishment Complete message on the reverse traffic channel, the AT transmits data on an existing reverse traffic channel and the newly established reverse traffic channel simultaneously.

An access terminal (AT) including an access terminal body, the AT further includes a reverse traffic channel establishment control unit and a carrier request message sending unit;

the carrier request message sending unit is adapted to send a carrier request message to the AN according to a control signal sent from the reverse traffic channel establishment control unit. The carrier request message carries a reverse carrier request ID identifying the number of reverse carrier links that the AT needs;

the reverse traffic channel establishment control unit is adapted to receive a Traffic Channel Assignment message sent from the AN, and establish a reverse traffic channel of the AT according to the Traffic Channel Assignment message.

The AT further includes:

a reverse Traffic Channel Establishment Complete message sending unit adapted to send a Reverse Traffic Channel Establishment Complete message on a newly established reverse traffic channel.

The AT further includes:

a timer unit adapted to time the establishment of a reverse channel connection after the Carrier Request message is sent.

The present invention has the following beneficial effects:

1. The AT initiates a Carrier Request message on its own initiative to request a reverse carrier link from the AN;

2. The message includes information about the number of reverse carrier links that the AT needs;

3. The AT may send a message for requesting a reverse carrier link in both idle state and connected state; and

4. The message for requesting a reverse carrier link sent from the AT to the AN may be sent on both an access channel and a reverse traffic channel.

### BRIEF DESCRIPTION OF THE DRAWINGS

FIG. 1 is a structural diagram of a multi-carrier EV-DO system of the prior art;

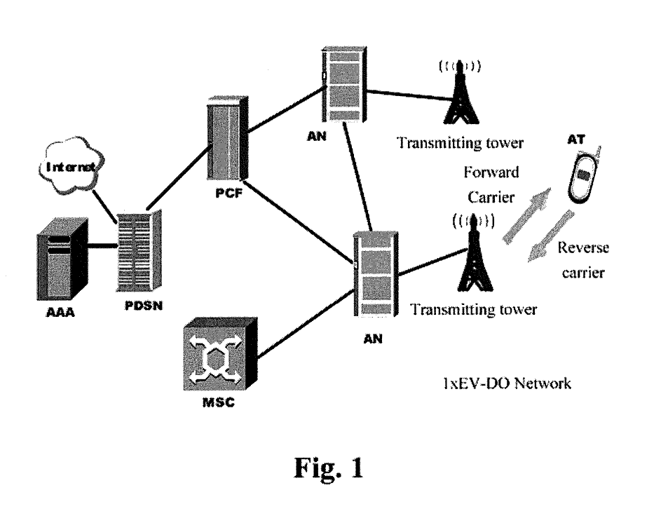

FIG. 2 is a flow chart of a process in which an AT initiates a connection request in the prior art;

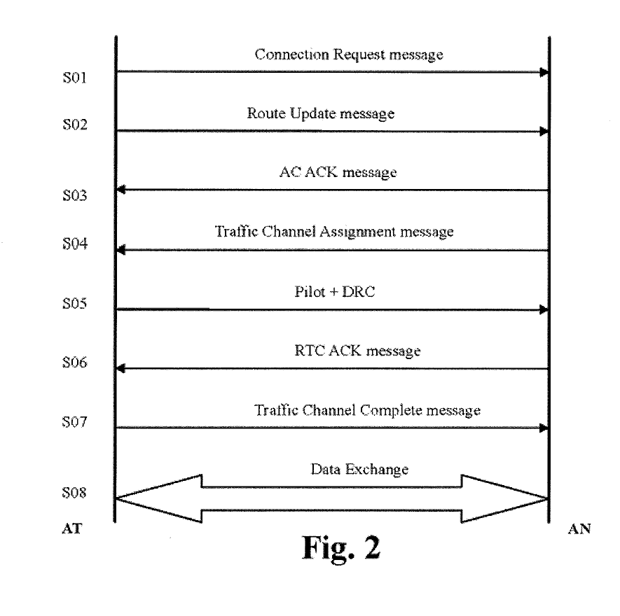

FIG. 3 is a block diagram showing the structure of an AT according to the present invention;

FIG. 4 is a flow chart of an embodiment 1 of the present invention;

FIG. 5 is a flow chart of an embodiment 2 of the present invention; and

FIG. 6 is a flow chart of an embodiment 3 of the present invention.

### DETAILED DESCRIPTION OF THE EMBODIMENTS

Embodiments of the present invention will now be illustrated in detail with reference to the drawings.

The technical solutions of the present invention may be applied to an NxEV-DO system, and may satisfy backward compatibility to a 1xEV-DO system when improved on the basis of the C.S0024-A-V1.0 protocol specification.

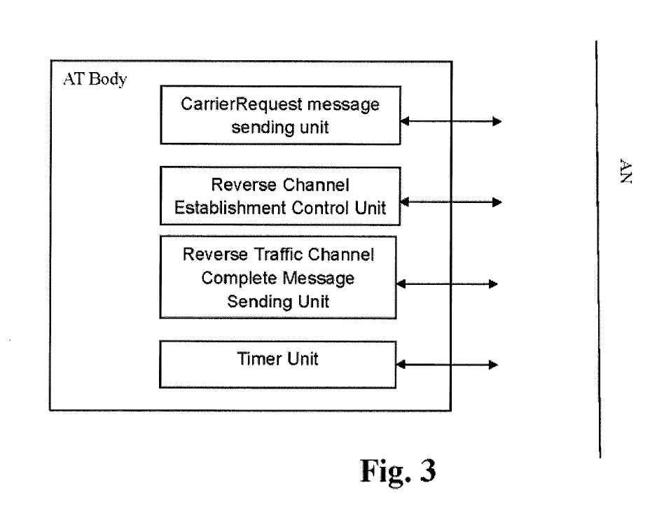

FIG. 3 shows a structural schematic diagram of an AT according to the present invention. As shown in FIG. 3, the AT has two logic functional units in addition to the existing terminal body: a reverse traffic channel establishment control unit and a carrier request message sending unit.

The AT uses the functional units to exchange a Carrier Request message with an AN, and to establish a reverse traffic channel.

The carrier request message sending unit sends a Carrier Request message to the AN according to a control signal sent from the reverse traffic channel establishment control unit. The Carrier Request message carries a reverse carrier request ID to identify the number of reverse carrier links that the AT needs.

The reverse traffic channel establishment control unit receives a Traffic Channel Assignment message sent from the AN, and establishes a reverse traffic channel of the AT according to the Traffic Channel Assignment message.

The above AT may be further provided with:

a reverse Traffic Channel Establishment Complete message sending unit adapted to send a Reverse Traffic Channel Establishment Complete message on a newly established reverse traffic channel; and

a timer unit adapted to time the establishment of a reverse channel connection after the Carrier Request message is sent.

The present invention sets a CarrierRequest message. The CarrierRequest message carries a reverse carrier request ID identifying the number of reverse carrier links that the AT needs. The AT sends the CarrierRequest message to the AN to request the number of reverse carriers that the AT needs.

TABLE 1
Filed Information of a Carrier Request Message

| Fields | Length (Bits) |
|---|---|
| Message ID | 8 |
| Transaction ID | 8 |
| Num Reverse Channels | 4 |
| Reserved | 4 |

Explanation of the fields:

Message ID is a message identification set by the AT. Each message corresponds to a unique Message ID to distinguish different messages.

Transaction ID is a transaction identification. The value of this field is increased each time the AT sends a new Reverse Channel Request message.

With this field, the Reverse Channel Request message sent each time can be distinguished. Thus, when the receiving side receives a Reverse Channel Request message, it may judge whether the Reverse Channel Request message is a new Reverse Channel Request Message. If the Reverse Channel Request Message is not a new one, it may be left not processed. If the Reverse Channel Request Message is a new one, a corresponding traffic channel will be allocated to the AT.

Num Reverse Channels: An AT sets this field as the number of reverse link carriers it requests to allocate subtracted by 1. With this field, the number of reverse link carriers that the AT needs can be identified.

Reserved: An AT sets this field as 0, and this field will be ignored when the AT receives the message.

TABLE 2
Filed Information of Message

| Channel | Access Channel, Reverse Traffic Channel |
|---|---|
| Addressing | Unicast |
| SLP | Best Effort |
| Priority | 40 |

The information fields in Table 2 are included in each message, wherein:

Channel: Channel identifies on which channel the message may be sent, for example, the message may be sent on an access channel and a reverse traffic channel.

Addressing: Addressing identifies that the message is sent in unicast mode, not in broadcast mode or multicast mode.

SLP: SLP identifies that the message is sent in Best Effort mode. In this case the message is only sent once and may be lost during the transmission.

Priority: Priority identifies the priority of sending the message, and the less the value is, the higher the priority will be.

### Embodiment 1

An AT initiates a request on its own initiative in an idle state.

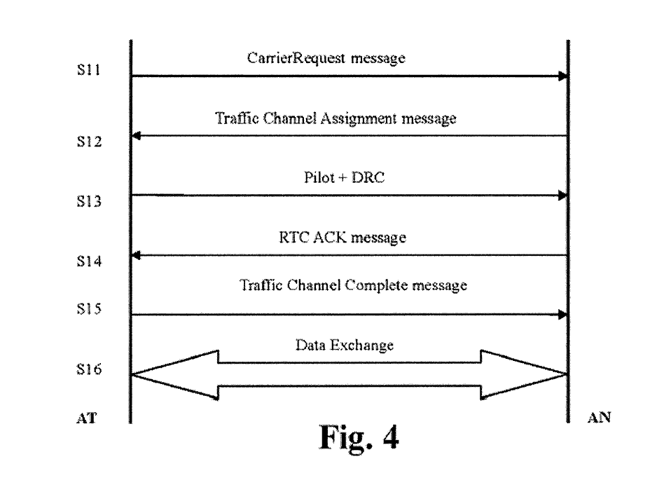

FIG. 4 is a flow chart of an embodiment 1 of the present invention. In the embodiment 1, an AT initiates a request on its own initiative in an idle state. As shown in FIG. 4, the embodiment 1 of the present invention mainly includes:

S11: The AT sends a CarrierRequest message to an AN on an access channel to request the expected number of reverse carrier links.

S12: The AN sends a Traffic Channel Assignment message. The Traffic Channel Assignment message includes specific information of forward and reverse channels.

The channel information packets included in the message are substantially as follows.

Forward channel information includes carrier frequency of a forward carrier link, sector information, MAC index information allocated to the AT (for identifying a data packet sent to the AT), etc.;

Reverse channel information includes carrier frequency of a reverse carrier link, MAC index information of a power control channel for controlling the transmission power of the reverse channel, index information of a forward channel for sending the power control channel, etc.

S13: The AT establishes a newly assigned reverse traffic channel according to the content provided in the Traffic Channel Assignment message, and sends its Pilot and DRC signal.

The pilot is adapted to assist the AN to capture a reverse channel.

A DRC signal is sent on a data rate control channel. The AT sends this channel to inform the AN of the rate of the requested forward traffic channel and the selected service sector.

S14: The AN sends an RTC ACK message acknowledging receipt of the reverse traffic channel.

S15: The AT sends a Traffic Channel Establishment Complete message on the reverse traffic channel and stops the timer.

The AT starts a timer when it sends a connection request. If the connection is established within a time period scheduled by the timer, the timer will be stopped; otherwise, the timer will be expired, and the AT will turn to another state.

S16: The AT and the AN start to exchange data on the newly assigned traffic channel.

### Embodiment 2

An AT initiates a request in a service state.

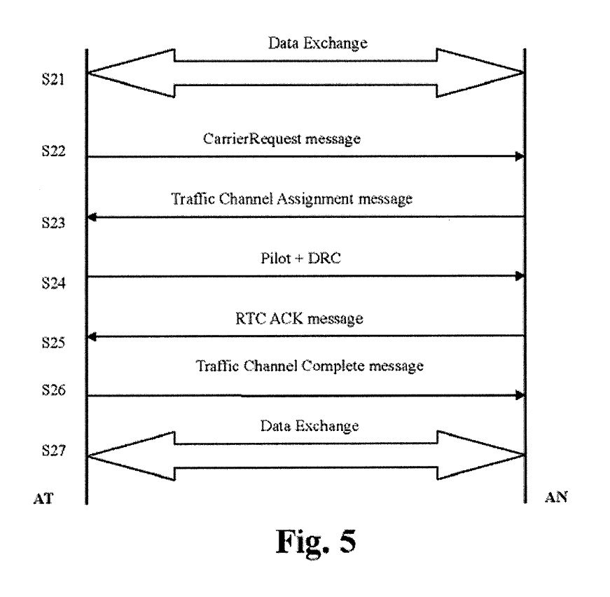

FIG. 5 shows a flow chart of an embodiment 2 of the present invention. In the embodiment 2, an AT initiates a request in a service state. As shown in FIG. 5, the embodiment 2 of the present invention mainly includes:

S21: Data exchange is performed on a traffic channel originally established between the AT and the AN.

S22: The AT sends a CarrierRequest message to the AN on an existing reverse traffic channel to request the expected number of reverse carrier links.

S23: The AN sends a Traffic Channel Assignment message. The Traffic Channel Assignment message includes specific information of forward and reverse traffic channels.

S24: The AT establishes a newly assigned reverse traffic channel according to the content provided in the Traffic Channel Assignment message, and sends its Pilot and DRC signal.

S25: The AN sends an RTC ACK message acknowledging receipt of the reverse traffic channel.

S26: The AT sends a Traffic Channel Establishment Complete message on the reverse traffic channel and stops a timer.

S27: The AT and the AN start to exchange data on the existing traffic channel and the newly assigned traffic channel simultaneously.

### Embodiment 3

In the embodiment 3, an AT initiatively requests a reverse carrier from an AN by extending Route Update message in C.S0024-A-V1.0.

TABLE 3
Extension of Routing Update message

| Fields | Length(bits) |
|---|---|
| Message ID | 8 |
| Message Sequence | 8 |
| Reference Pilot PN | 9 |
| Reference Pilot Strength | 6 |
| Reference Keep | 1 |
| Num Pilots | 4 |

The following fields appear for times of Num Pilots:

| | |
|---|---|
| Pilot PN Phase | 15 |
| Reverse Channel Included | 1 |
| Channel | 24 |
| Pilot Strength | 6 |
| Keep | 1 |

Fields of a carrier request:

| | |
|---|---|
| CarrierRequest | 1 |
| Num Channels | 0 or 4 |
| Reserved | Variable |

The last 3 fields (i.e., CarrierRequest, Num Channels and Reserved) are newly added fields. The other field information of this message is consistent with the field information of a message in C.S0024-A-V1.0.

In the embodiment 3, modification is made on the basis of C.S0024-A-V1.0, and a field CarrierRequest is added. When this field is set as “1”, it indicates that the message is to request the number of reverse carriers that the AT needs from the AN. Thus, Num Channels is the number of reverse carriers requested by the AT. In this case, Num Pilots is set as “0000”, and none of the corresponding pilot information fields below Num Pilots is included in the message. Upon receiving the message, the AN returns a Traffic Channel Assignment message. The Traffic Channel Assignment message includes specific information of a reverse channel allocated to the AT by the AN. If the field Reverse Channel Included in a Route Update message is set as “0”, this message has the same function as a Route Update message defined in C.S0024-A-V1.0. In this case, field Num Channels shall not be included in the message.

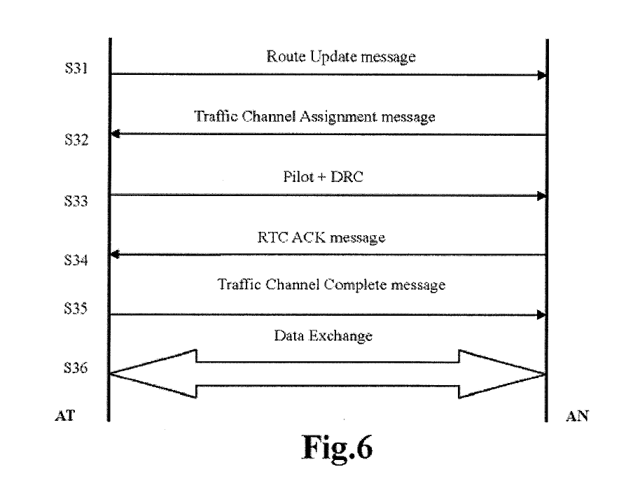

FIG. 6 is a flow chart of an embodiment 3 of the present invention. As shown in FIG. 6, the embodiment 3 mainly includes:

S31: An AT sends a Route Update message on a reverse traffic channel to request the expected number of reverse carrier links. The field CarrierRequest in the message is “1”, Num Pilots is set as “0000”, and none of the pilot information fields corresponding to Num Pilots (i.e., Pilot PN Phase, Reverse Channel Included, Channel, Pilot Strength, Keep) is included in the message. The field Num Channels is set as the number of reverse carriers requested by the AT.

S32: The AN sends a Traffic Channel Assignment message. The Traffic Channel Assignment message includes specific information of the forward and reverse channels.

S33: The AT establishes a newly assigned reverse channel according to the content provided in the Traffic Channel Assignment message, and sends its Pilot and DRC signal.

S34: The AN sends an RTC ACK message acknowledging receipt of the reverse traffic channel.

S35: The AT sends a Traffic Channel Establishment Complete message on the reverse traffic channel and stops the timer.

S36: The AT and the AN start to exchange data on the previously existing traffic channel and the newly assigned traffic channel simultaneously.

In the above embodiment 3, there exists a reverse traffic channel that has been established. This solution is applicable to the case of the embodiment 1, i.e., the case in which an AT initiates a request on its own initiative in an idle state.

By the technical solutions of the present invention, an AT may request required number of reverse carriers from an AN initiatively according to its own demand. Thus, the AT can request a reverse carrier from the AN flexibly and dynamically according to its own demand. Therefore, a burst data traffic may be effectively processed during a service process.

Additional variations and modifications will readily occur to those skilled in the art without departing from the spirit or scope of the present invention. Thus, if such variations and modifications fall into the appended claims and their equivalents, they will be covered by the present invention.

1. A method for establishing a reverse channel comprising:
sending, by an access terminal, a CarrierRequest message to an access network, wherein the CarrierRequest message carries a reverse carrier request indicator that indicates the number of reverse carrier links that the access terminal needs;
receiving, by the access terminal, a Traffic Channel Assignment message carrying reverse traffic channel information from an access network; and
establishing, by the access terminal, a reverse traffic channel according to the Traffic Channel Assignment message.

2. The method according to claim 1 further comprising:
sending a Pilot and a DRC signal to inform the access network of the rate of the requested forward traffic channel and the selected service sector.

3. The method according to claim 1 further comprising:
receiving a RTC ACK (Reverse Traffic Channel Complete ACK) message from the access network acknowledging receipt of the reverse traffic channel, and
sending a Traffic Channel Establishment Complete message in response to the receiving the RTC ACK message.

4. The method according to claim 1, wherein, the sending the CarrierRequest message to the access network is sending the CarrierRequest message to the access network on an access channel.

5. The method according to claim 1, wherein the sending the CarrierRequest message to the access network is sending the CarrierRequest message to the access network on a reverse traffic channel that has been established between the access terminal and the access network.

6. The method according to claim 1, wherein, the CarrierRequest message is obtained by extending a Route Update message, and extending the Route Update message is implemented by adding a reverse carrier request field to the Route Update message.

7. The method according to claim 1, further comprising sending, by the access terminal, sending data through the reverse traffic channel.

8. The method according to claim 1, wherein the reverse carrier request indicator comprises a Message ID, and a reverse link carrier number indicator.

9. The method according to claim 3, wherein, the sending the Reverse Traffic Channel Establishment Complete message further comprises:
sending a Reverse Traffic Channel Establishment Complete message on the established reverse traffic channel.

10. The method according to claim 3, the sending the CarrierRequest message to the access network further comprises starting a timer, and the method further comprising:
turning off the timer in response to sending the Traffic Channel Establishment Complete message.

11. The method according to claim 7, wherein, the sending data through the reverse traffic channel further comprises: the access terminal sending data on an existing reverse traffic channel and the established reverse traffic channel.

12. A method for establishing a reverse channel comprising:
receiving, by an access network, a CarrierRequest message from an access terminal, wherein the CarrierRequest message carries a reverse carrier request indicator that indicates the number of reverse carrier links that the access terminal needs;
sending, by the access network, a Traffic Channel Assignment message carrying reverse traffic channel information to the access terminal for the access terminal to establish a reverse traffic channel according to the Traffic Channel Assignment message and to send a Pilot and a DRC signal.

13. The method according to claim 12, wherein, the receiving the CarrierRequest message from the access terminal is receiving the CarrierRequest message from the access terminal on an access channel.

14. The method according to claim 12, wherein, the receiving the CarrierRequest message from the access terminal is receiving the CarrierRequest message from the access terminal on a reverse traffic channel that has been established between the access terminal and the access network.

15. The method according to claim 12, wherein the CarrierRequest message is an extended Route Update message with a reverse carrier request field.

16. The method according to claim 12, further comprising receiving, by the access network, a Traffic Channel Establishment Complete message, and receiving data through the reverse traffic channel.

17. The method according to claim 12, wherein the reverse carrier request indicator comprises a Message ID, and a reverse link carrier number indicator.

18. The method according to claim 16, wherein the receiving the Traffic Channel Establishment Complete message on the reverse traffic channel further comprises:
receiving, by the access network, a Reverse Traffic Channel Complete ACK message acknowledging receipt of the reverse traffic channel.

19. The method according to claim 16, wherein the receiving the Traffic Channel Establishment Complete message on the reverse traffic channel further comprises:
receiving, by the access network, a Reverse Traffic Channel Establishment Complete message on the newly established reverse traffic channel.

20. The method according to claim 16, wherein, the receiving the Traffic Channel Establishment Complete message on the reverse traffic channel further comprises: the access network receives data on an existing reverse traffic channel and the newly established reverse traffic channel.

21. An access terminal for establishing a reverse channel, the terminal comprising:
a reverse traffic channel establishment control unit adapted to generate a control signal, receive a Traffic Channel Assignment message sent by a access network, and establish a reverse traffic channel of the access terminal according to the Traffic Channel Assignment message; and
a carrier request message sending unit, adapted to send a CarrierRequest message to an access network according to the control signal, the CarrierRequest message carrying a reverse carrier request indicator indicating the number of reverse carrier links that the access terminal needs.

22. The access terminal according to claim 21 further comprising:
a Reverse Traffic Channel Establishment Complete message sending unit adapted to send a Reverse Traffic Channel Establishment Complete message on a newly established reverse traffic channel in response to establishment of a reverse traffic channel of the access terminal according to the Traffic Channel Assignment message.

23. The access terminal according to claim 22 further comprising:
a timer unit adapted to time the establishment of a reverse channel connection after the Carrier Request message is sent.

24. An access terminal for establishing a reverse channel comprising: a processor configured to perform a method comprising:
sending a CarrierRequest message to an access network, wherein the CarrierRequest message carries a reverse carrier request indicator that indicates the number of reverse carrier links that the access terminal needs;
receiving, a Traffic Channel Assignment message carrying reverse traffic channel information from an access network; and
establishing, a reverse traffic channel according to the Traffic Channel Assignment message.

25. The access terminal according to claim 24, wherein the method further comprises
sending a Pilot and a DRC signal to inform the access network of the rate of the requested forward traffic channel and the selected service sector.
